(19) United States
(12) Patent Application Publication
(10) Pub. No.: US 2014/0167404 A1
(43) Pub. Date: Jun. 19, 2014

(54) Components for Fabrication of a Stable Base and Support Structure

(71) Applicant: Robert H. WILSON, Austin, TX (US)

(72) Inventor: Robert H. WILSON, Austin, TX (US)

(21) Appl. No.: 13/948,088

(22) Filed: Jul. 22, 2013

Related U.S. Application Data
(60) Provisional application No. 61/674,084, filed on Jul. 20, 2012.

(51) Int. Cl. F16L 21/00; F16L 41/03

(52) U.S. Cl. CPC F16L 21/00; F16L 41/03
USPC 285/61; 285/125.1

(57) ABSTRACT

A tetrahedron shaped pipe section core connector and an optional end connector that enable the quick fabrication of a stable tripod base with a stable post support. The core connector is made by machining, molding, casting, or forging the material from which the pipe connector is constructed (typically metal or plastic). The core component (hereinafter the “knuckle connector”) provides four pipe connections oriented at 109.5° angles to each other, forming a regular tetrahedron shape. Pipe sections may be screwed or press fit into each of the four pipe connections. Three of these fitted pipes may be oriented to form a tripod base. The remaining pipe connection extends vertically up to form a post support. The body of the knuckle connector optionally incorporates one or more smaller apertures, preferably threaded, that extend through the wall of the body of the connector. These apertures provide attachment points for ancillary components.

### CROSS REFERENCES TO RELATED APPLICATIONS

This application claims the benefit under Title 35 United States Code §119(e) of U.S. Provisional Patent Application Ser. No. 61/674,084, filed Jul. 20, 2012, the full disclosure of which is incorporated herein by reference.

### BACKGROUND OF THE INVENTION

1. Field of the Invention

The present invention relates generally to connector components that facilitate the fabrication of structural supports and frames. The present invention relates more specifically to pipe section connectors structured to enable the quick fabrication of a stable base and support frame.

2. Description of the Related Art

Efforts have been made in the past to provide connectors and other structural components that facilitate the assembly of support bases, support posts, and other framework type structures. Whether constructed of metal pipes or PVC pipes and the like, such connectors have generally been limited to inline connections, right angle connections, 135° (45° deviation) angle connections, as well as T-connectors and Y-connectors. Rectangular frames and 45° angle frames can therefore be constructed from various types of existing pipe connectors.

No effort has been made in the past, however, to construct tetrahedral shaped components that would enable the quick fabrication of a stable tripod base with a stable post support structure. A tripod base is known to provide a stable support for a single post or platform as is implemented in camera tripods and the like. Currently, implementation of a tripod structure from standard pipe connectors and the like would require multiple T-connectors and multiple 135° connectors, all associated with a number of short lengths of pipe section.

### SUMMARY OF THE INVENTION

A tetrahedron shaped connector would enable the quick fabrication of a stable tripod base with a stable post support structure as is described in the present invention. The tetrahedron shaped connector is a single piece part made by machining, molding, casting, forging or some other manufacturing means associated with the material from which the pipe connector is constructed (typically metal or plastic). The basic tetrahedron shaped component (hereinafter referred to as a “knuckle connector”) provides four pipe connections oriented at 109.5° angles to each other, forming a regular tetrahedron configuration. [The pipe connections are 120° from each other on a projection plane.] Pipe sections may be screwed or press fit into each of the four pipe connections. Three of these fitted pipes may be oriented to form a three-point (tripod) stable base. The remaining top pipe connection may extend vertically up to form a post support for a variety of uses.

The body of the tetrahedron shaped connector, or knuckle connector, optionally incorporates four smaller apertures, preferably threaded, that extend through the body of the connector opposite each of the pipe connections. These threaded apertures provide attachment points for screw or eye bolt structures that may be used for a hold down point or other support points for a variety of different assembled structures. Further objectives of the present invention will become apparent from an understanding of the following detailed description and the attached drawing figures which may be briefly described as follows.

### BRIEF DESCRIPTION OF THE DRAWINGS

FIG. 1 is a detailed perspective view of the knuckle connector component of the system of the present invention.

FIG. 2 is a top plan view of the knuckle connector component of the system of the present invention.

FIG. 3 is a front elevational view of the knuckle connector component of the system of the present invention.

FIG. 4 is a base plan view of the knuckle connector component of the system of the present invention.

FIG. 5 is a side elevational view of the knuckle connector component of the system of the present invention.

FIG. 6 is a rear elevational view of the knuckle connector component of the system of the present invention.

FIG. 7 is a detailed perspective view of the foot connector component of the system of the present invention.

FIG. 8 is a top plan view of the foot connector component of the system of the present invention.

FIG. 9 is a rear elevational view of the foot connector component of the system of the present invention.

FIG. 10 is a base plan view of the foot connector component of the system of the present invention.

FIG. 11 is a side elevational view of the foot connector component of the system of the present invention.

FIG. 12 is a front elevational view of the foot connector component of the system of the present invention.

FIG. 13 is a perspective view of a light support implementation of the various components of the system of the present invention.

FIG. 14 is a side elevational view of a table support implementation of the various components of the system of the present invention.

FIG. 15 is a partial cross-sectional side elevational view of a paper towel holder implementation of the various component of the system of the present invention.

FIG. 16 is a side elevational view of a guitar stand implementation of the various components of the system of the present invention.

FIG. 17 is a side elevational view of a water mister implementation of the various components of the system of the present invention.

### DETAILED DESCRIPTION OF THE PREFERRED EMBODIMENTS

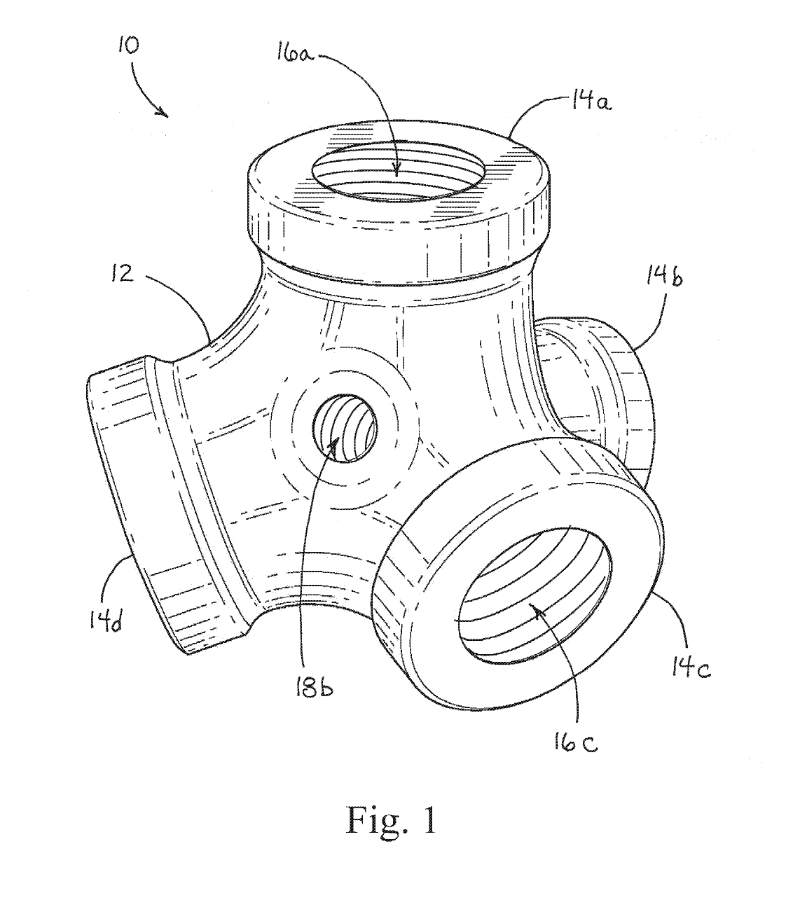

Reference is made first to FIG. 1 for a detailed description of the core component of the system of the present invention. FIG. 1 shows a perspective view of knuckle connector 10 that forms the primary component utilized in the construction of a variety of support structures utilizing the system of the present invention. Knuckle connector 10 is a tetrahedral shaped connector made up of knuckle body 12 with four knuckle extensions 14a-14d. Each of the knuckle extensions 14a-14d provides a knuckle port 16a-16d. In the preferred embodiment of the present invention each of knuckle ports 16a-16d is a threaded port structured to receive a section of threaded pipe. Alternate embodiments may utilize non-threaded pipe sections which would not require threaded ports.

Opposing each of the knuckle extensions 14a-14d and knuckle ports 16a-16d, through the wall of knuckle body 12 are ancillary apertures 18a-18d. Here again, in the preferred embodiment, ancillary apertures 18a-18d are preferably threaded apertures. Such ancillary apertures 18a-18d may or may not be utilized in any specific construction implementation of the system of the present invention.

A preferred embodiment of the system of the present invention is sized and structured to be implemented in conjunction with standard sized pipe sections. One of the most commonly used standards is the Nominal Pipe Size (NPS) Standard that includes NPS ½″ and NPS ¾″ sizes. These two pipe sizes are among the more common used in conjunction with threaded iron pipe materials. Similar sizes may be identified in conjunction with common PVC pipe materials, typically non-threaded, and secured using PVC cement.

Although the detailed description herein will reflect a typical NPS ½″ set of components in conjunction with NPT ½″ (National Pipe Thread Taper) threaded construction. Those skilled in the art will recognize however that the basic configuration of the components of the system of the present invention lend themselves to implementation in conjunction with a wide range of pipe sizes. The actual size of the pipe, and therefore the connector construction based on the system of the present invention, will depend on the particular application (the weight that must be supported) and the various other forces that the frame or support structure will be subjected to. Most of the assemblies of the components of the system of the present invention described herein may best be implemented in conjunction with NPS ½″ iron pipe.

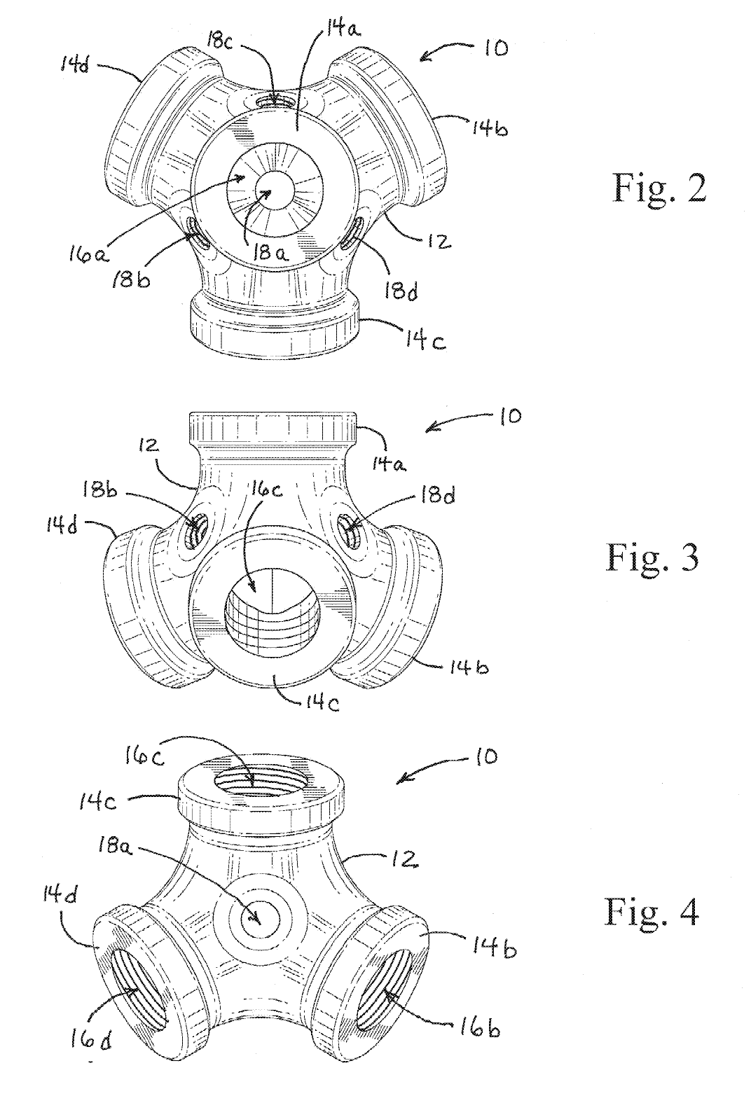

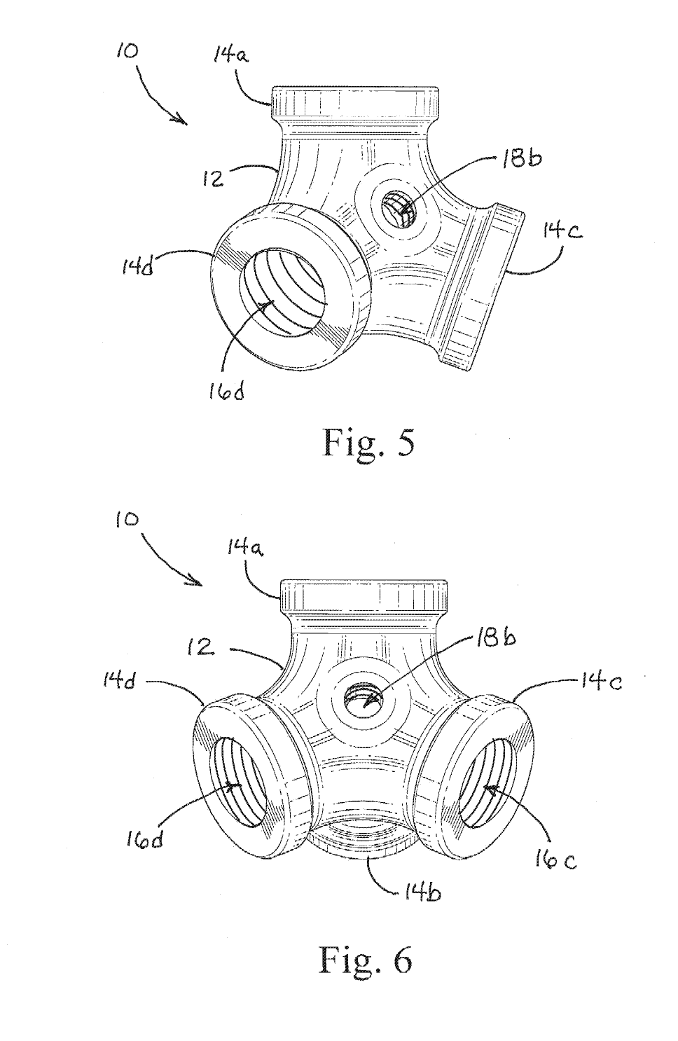

FIGS. 2-6 provide additional details of the tetrahedral shaped knuckle connector 10 of the system of the present invention, disclosing in the various views all of the knuckle extensions 14a-14d, all of the knuckle ports 16a-16d, and all of the ancillary apertures 18a-18d formed through the wall of knuckle body 12.

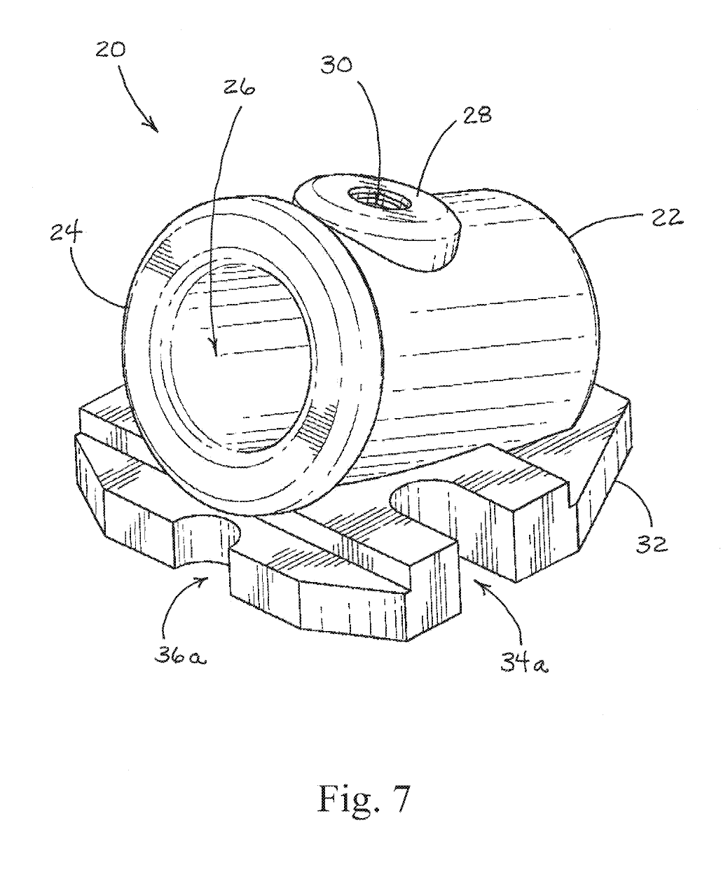

Reference is next made to FIG. 7 for a detailed description of one type of foot connector component used in the system of the present invention. Although the knuckle connector 10 described above may be utilized in conjunction with pipe sections and no other additional components, it may be preferable to provide specifically designed components that support and/or attach the pipe sections on flat surfaces. Each of the tripod pipe sections may simply be capped with standard sized threaded caps, although in many circumstances it would be preferable to provide a foot component with a flat base surface. Such a flat base surface could provide greater stability through increased contact with the floor or could provide a means for attaching the feet, and therefore the overall structure, to the floor or platform surface. Such foot connectors may additionally be utilized to provide a flat support in an inverted configuration for the underside of table tops and the like (described in more detail below).

Foot connector 20 is sized and structured in a manner to receive a pipe section that extends from knuckle connector 10 as described above. Foot connector 20 is made up of foot body 22 with a single foot extension 24 configured at an angle. In order to receive a pipe section extending from the knuckle connector (oriented 109.5° from the vertical) the angle of foot extension 24 and foot port 26 from the horizontal (the plane of the floor) should be approximately 19.5°. While this angle is consistent with the 109.5° angle from the vertical for the tetrahedron, the length of the connecting pipe section (see description below) may vary which will result in a variation of the elevation of the knuckle connector from the floor or platform.

Foot connector 20 in the preferred embodiment of the present invention preferably does not include a threaded foot port 26 as orientation of the foot connector with regard to the knuckle connector is facilitated by having a smooth internal diameter wherein the pipe section may then be fixed in place by means of a set screw positioned within set screw extension 28 through set screw aperture 30. In this manner, a section of pipe may be threaded at one end and secured within the knuckle connector and tightened so as to be secure, followed by the attachment of the foot connector whose orientation may be established without the need for tightening a threaded section. A standard set screw (not shown) may be positioned within threaded set screw aperture 30 and tightened to secure the end of the pipe section within foot connector 20.

Additionally forming part of foot connector 20 is foot base 32 which provides the flat surface onto which the foot connector 20 may rest on and/or be secured to. For securing foot base 32, and therefore foot connector 20, to a flat surface, a number of attachment slots are provided. Base side slots 34a & 34b provide deeper slots through which threaded bolts or screws may be used to secure foot connector 20 to a flat platform. Base end slots 36a & 36b may also provide means for aligning the foot connector and maintaining its position on a flat surface.

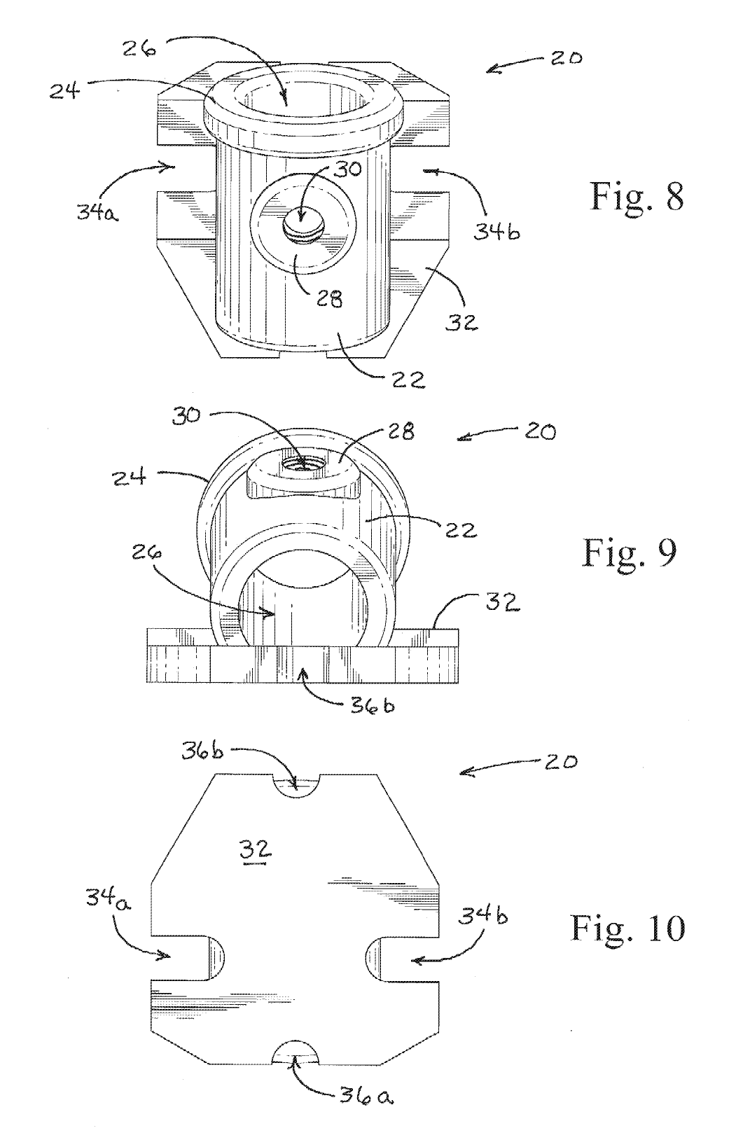

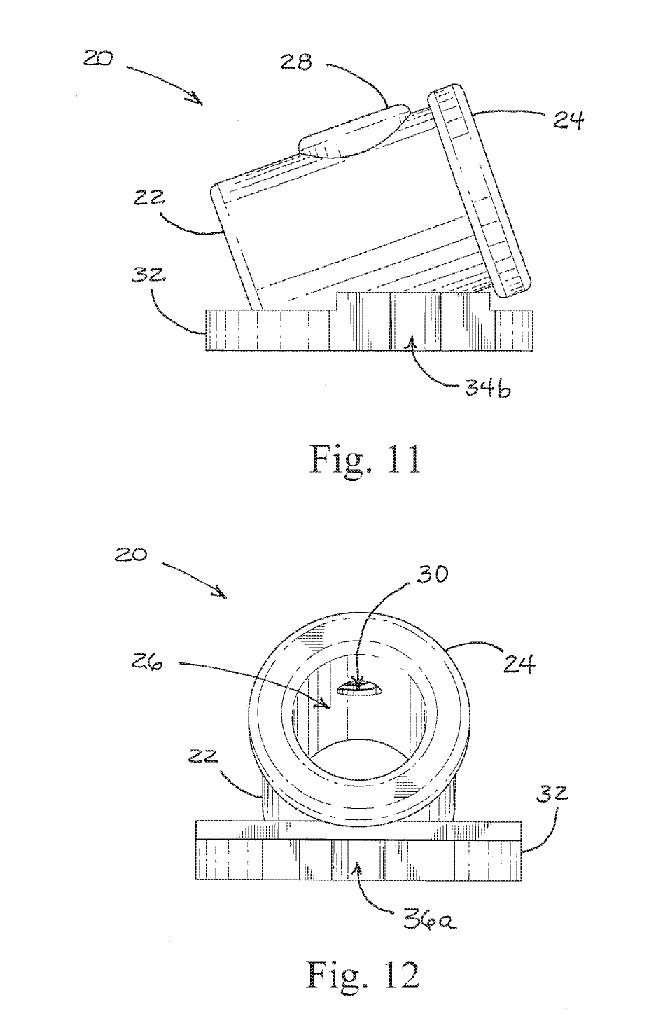

FIGS. 8-12 provide variously oriented view of foot connector 20 and, in combination, show all of the structural features of foot connector 20, including foot body 22, foot extension 24, foot port 26, set screw extension 28, set screw aperture 30, foot base 32, base side slots 34a & 34b, as well as base end slots 36a & 36b.

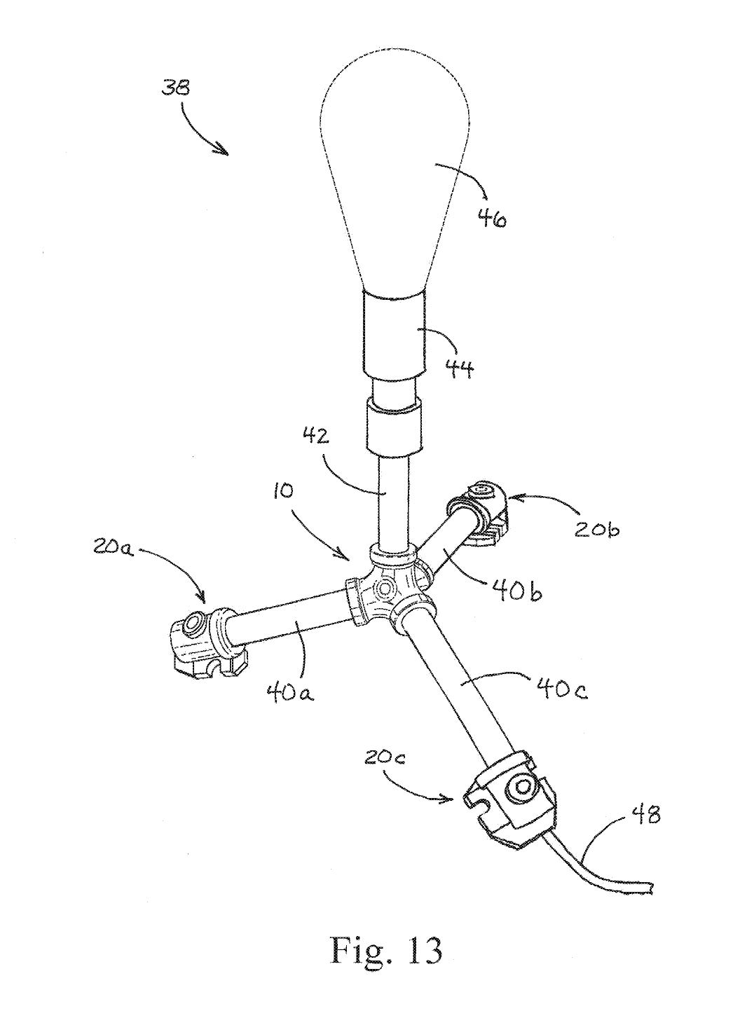

Reference is next made to FIG. 13 for a first example of an implementation of the components of the system of the present invention, providing for a stable tripod based stand. FIG. 13 shows an electrically powered visual display device, such as a beacon, lamp, or other electrically powered light source. Light stand 38 is constructed using a single knuckle connector 10 and three foot connectors 20a-20c. Associated with each of these leg connections are tripod legs 40a-40c. Extending upward from knuckle connector 10 is tripod post 42. A light socket 44 is positioned at the top of tripod post 42 and a light bulb 46 is positioned within the light socket. An electrical cord 48 is configured within the components of the system, preferably running through one of the foot connectors up through one of the tripod legs, through the knuckle connector and up the tripod post to the light socket. Alternate routes for running the electrical cord 48 are anticipated.

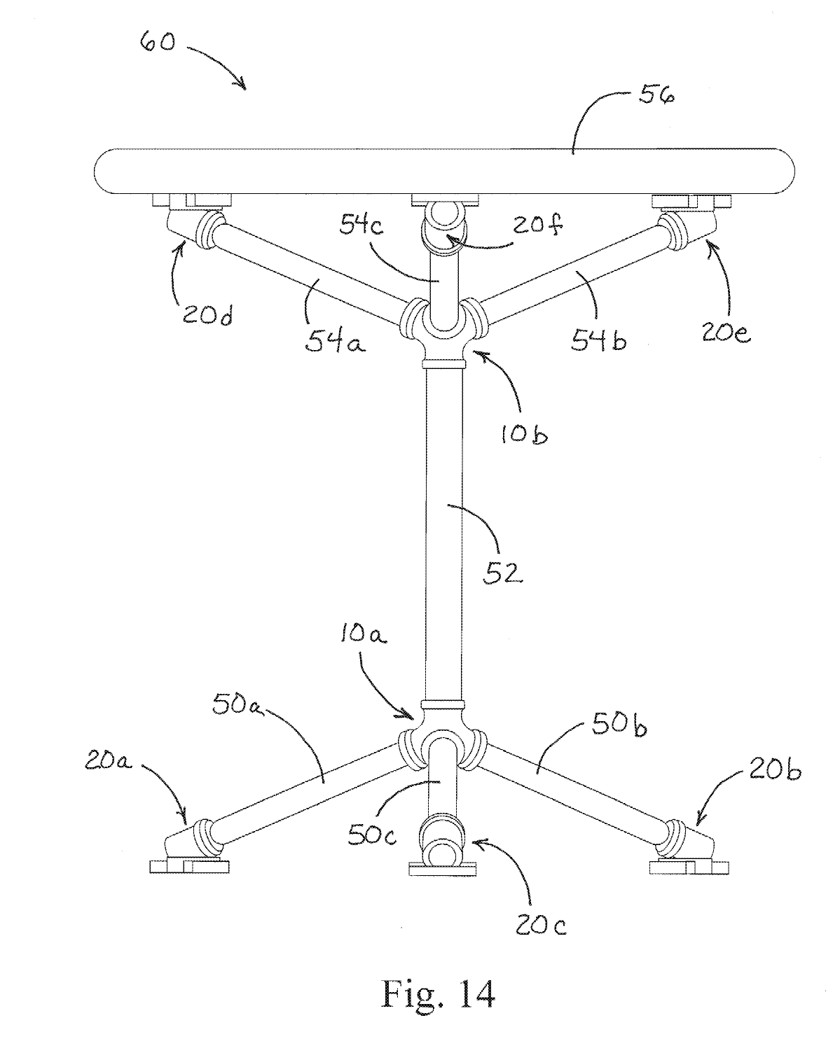

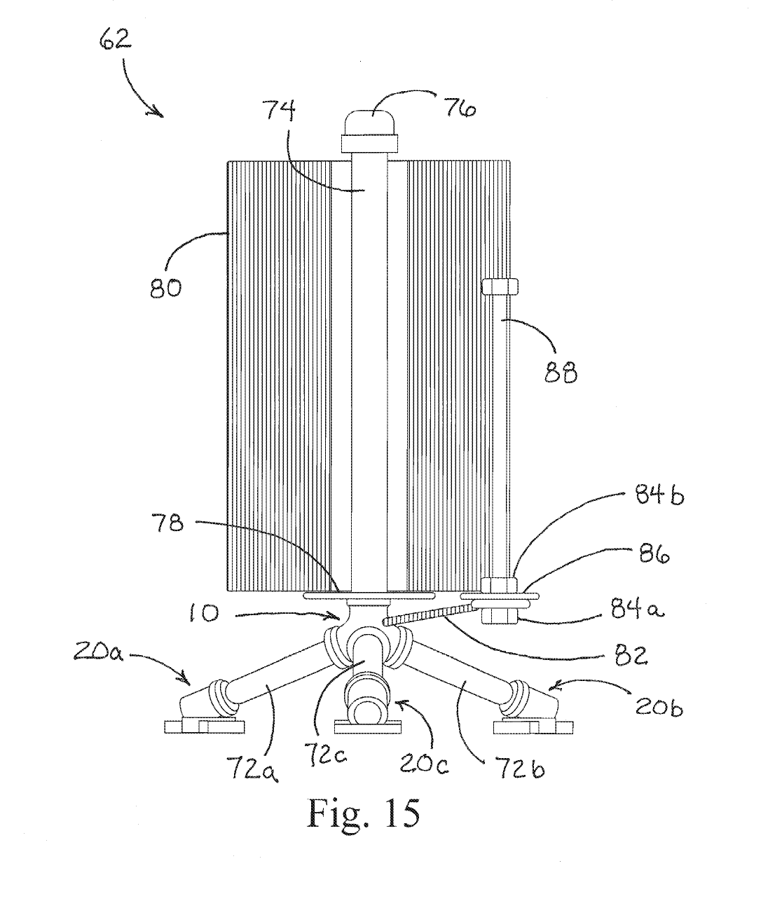

Reference is next made to FIG. 14 for a detailed description of an assembled table structure utilizing the components of the system of the present invention. The assembled table 60 shown in FIG. 14 is constructed using two knuckle connectors 10a & 10b, one of which is used to form the base of the table, while the second is used to provide support arms, holding and securing the table top. Knuckle connector 10a is fitted with three tripod legs 50a-50c in the manner described above. Each of the tripod legs 50a-50c is secured into a foot connector 20a-20c to form a stable tripod base.

Knuckle connector 10b is inverted and is positioned at the top end of tripod post 52 supported by knuckle connector 10a and forms the connector on which three support arms may be positioned. In this case, knuckle connector 10b is connected to and supports table support arms 54a-54c. Additional foot connectors 20d-20f are positioned on table support arms 54a-54c and are inversely oriented so as to provide their flat base surface upward to attach to or otherwise support table top 56. As with the tripod base components, the table may be constructed without the use of foot connectors, simply providing an evenly spaced and oriented array of three arms to support a horizontal surface. Table top 56 may simply be placed and secured on the stand under its own weight, or screws or bolts may be positioned through the appropriate slots in foot connectors 20d-20f to secure table top 56 in place. The basic construction in FIG. 14 lends itself not only to the fabrication of a table, but also to stools or other seating fixtures of varying heights. The structure shown in FIG. 14 discloses the basic mirrored orientation of the tripod base into a tripod arm support arrangement that may be utilized in conjunction with a wide variety of support structures.

Reference is next made to FIG. 15 for a further application of the basic components of the system of the present invention. FIG. 15 shows a paper towel dispenser 62 constructed from one knuckle connector 10 and three foot connectors 20a-20c. These components are connected together using tripod legs 72a-72c, typically shorter in length than those leg structures described above. Tripod post 74 extends up from knuckle connector 10 to form the axial pillar on which paper towel roll 80 is positioned. Tripod post 74 is capped with post cap 76. Supporting paper towel roll 80 is base washer 78 positioned on top of knuckle connector 10 and around tripod post 74. Paper towel roll 80 is free to rotate about tripod post 74 on top of base washer 78.

Extending from one of the ancillary apertures 18a-18d in knuckle connector 10 is threaded eyelet arm 82. Eyelet arm 82 is threaded at a first end and terminates in an eyelet at the extended end. The threaded end is threaded into ancillary aperture 18a as described above. The eyelet component of eyelet arm 82 is positioned to receive stay post bolt 88 which on a threaded end is secured through the eyelet using threaded nuts 84a & 84b along with washer 86. This assembly therefore provides a stay post 88 that helps to maintain the loose end of paper towel roll 80 adjacent the roll as is typical.

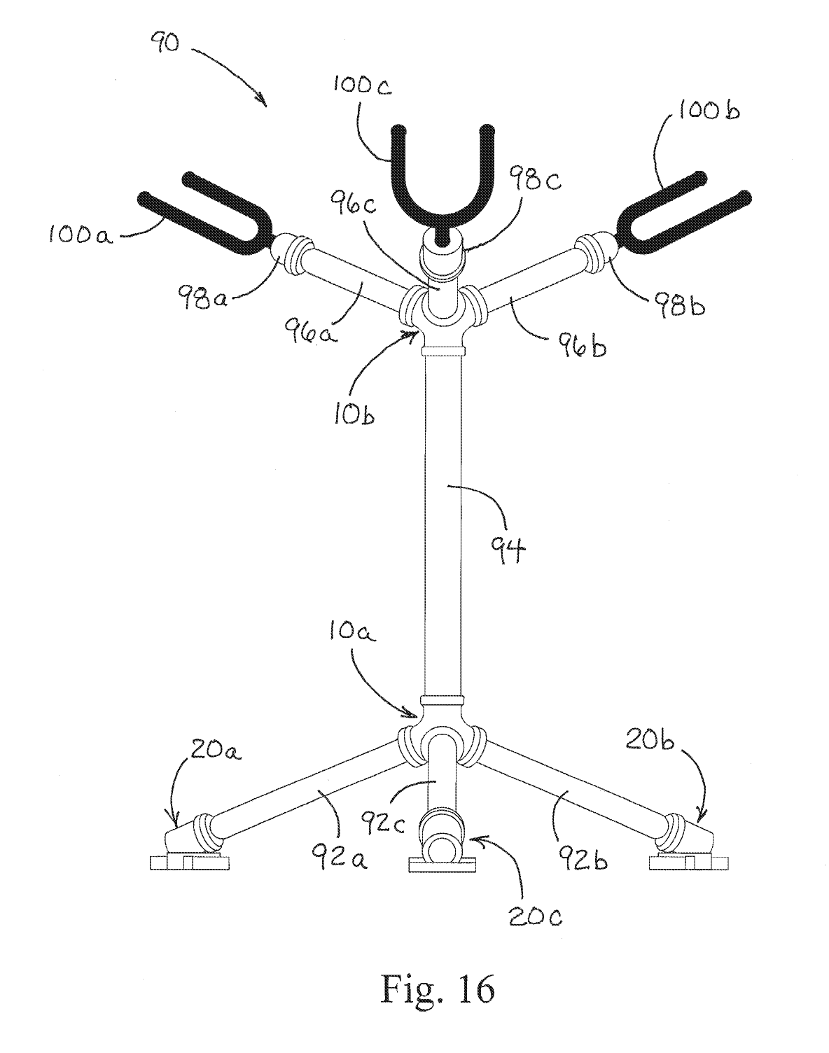

Reference is next made to FIG. 16 for a further structural assembly utilizing the basic components of the system of the present invention. FIG. 16 shows a guitar stand 90 capable of positioning as many as three guitars within fork brackets 100a-100c. Guitar stand 90 is constructed from a pair of knuckle connectors 10a & 10b forming a base and a three arm tree arrangement at the top. The base of guitar stand 90 is constructed in much the same manner as the above described structures, and includes tripod legs 92a-92c. Tripod post 74 extends up from knuckle connector 10a to knuckle connector 10b. Extending from knuckle connector 10b are support arms 96a-96c. Each of the support arms is capped with an arm cap 98a-98c which, in this embodiment, include a threaded aperture at the tip end of each cap. Within the threaded aperture are positioned fork brackets 100a-100c. The three support arms thus structured may preferably be rotated out of vertical alignment with the tripod legs so as to optimize the available space below each of the fork brackets for the guitar to be hung and supported. In a further alternate embodiment, a rotating connection may be made at some point on tripod post 94 so that the top tree assembly of the guitar stand may be rotated with respect to the base.

Alternate uses of the same basic construction shown in FIG. 16 are anticipated. Fork brackets 100a-100c may be utilized to hold stemmed glassware instead of guitars. In fact, any stemmed object having a larger head component attached to a thinner stem component may be hung or supported using the basic structure shown in FIG. 16. Additionally implemented in the space between support arms 96a-96c may be a flat platform such as a plate or table to support smaller loose objects within the center area of the overall stand.

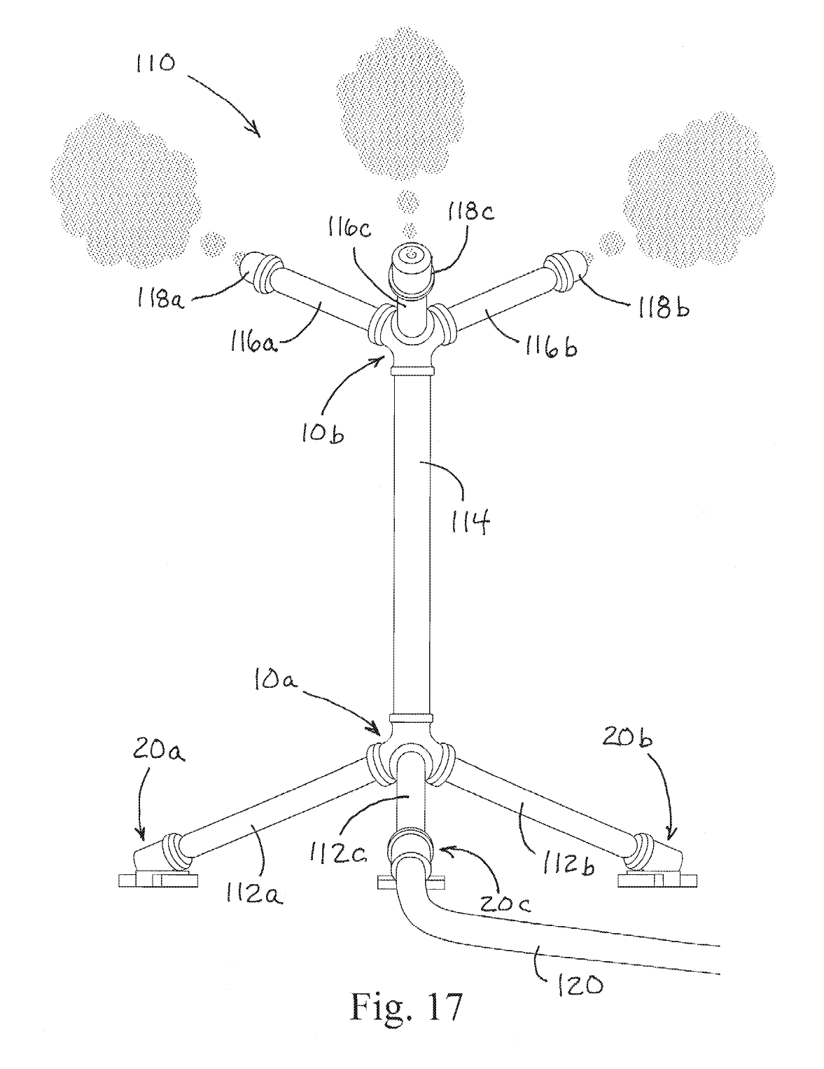

Reference is finally made to FIG. 17 for a brief description of a mister stand implementation of the basic components of the system of the present invention. Constructed in a manner very similar to that shown in FIG. 16, the mister stand 110 of FIG. 17 utilizes a pair of knuckle connectors 10a & 10b with the base knuckle connector 10a connected to three foot connectors 20a-20c through tripod legs 112a-112c. Tripod post 114 extends up from knuckle connector 10a to inverted knuckle connector 10b. Extending from inverted knuckle connector 10b are mister arms 116a-116c. Each of the mister arms 116a-116c terminates in a mister cap 118a-118c which each incorporate a spray nozzle at its tip in a manner that allows water under pressure to be forced through the nozzles and create a mist as shown.

The water supply for mister stand 110 preferably comes from an attachable hose 120 that may be connected through one of the foot connectors 20a-20c or may otherwise be connected to a point on the tripod post 114. Appropriate modifications of the foot connectors for receiving a hose connection and further for allowing a number of the mister stands to be connected in a series will be apparent to those skilled in the art.

Some modification of the mister stand shown in FIG. 17 may be made to implement the structure as a water sprinkler Placement of larger water jets on each of the mister arms would allow for water to be sprayed at a greater flow rate so as to provide an elevated sprinkler device. As with the rotational connection described above with guitar stand 90, a water tight rotational connection on tripod post 114 may be implemented to provide a sprinkler system that rotates.

Although the present invention has been described in conjunction with a number of preferred embodiments, those skilled in the art will recognize modifications to both the structure and the geometry of the individual components described that lend themselves to utilization in conjunction with alternate embodiments and alternate applications. The basic tetrahedral structure for the knuckle connector opens up a number of different fabrication systems that utilize both the knuckle connector at their core and the foot connectors for base support and inverted platform support. Once again, variations in the material from which the pipe sections are made are anticipated, as well as variations in the diameter of the pipe sections and the appropriately sized connector components. Each of these variations and modifications related to size and material are anticipated as falling within the spirit and scope of the invention.

I claim:

1. A pipe section core connector component comprising:
a connector body comprising a walled enclosure; and
four connector extensions, each oriented to generally form a regular tetrahedral shape, extending from the connector body, each of the four connector extensions comprising an internally threaded cylinder;
wherein the connector body further defines at least one threaded ancillary aperture positioned through the wall of the connector body.

2. A pipe section end connector component comprising:
a connector body comprising a base plate; and
a connector extension, oriented at an acute angle from the base plate, extending from the connector body, the connector extension comprising a walled cylinder;
wherein the walled cylinder of the connector extension further defines at least one threaded set screw aperture positioned through the wall of the connector extension.
